(19) United States
(12) Patent Application Publication
(10) Pub. No.: US 2022/0190780 A1
(43) Pub. Date: Jun. 16, 2022

(54) REFLECTIVE SOLAR PHOTOVOLTAIC SYSTEM

(71) Applicant: NANOVALLEY CO., LTD., Daejeon (KR)

(72) Inventor: Young-kwon Jun, Pohang-si (KR)

(21) Appl. No.: 17/531,990

(22) Filed: Nov. 22, 2021

(30) Foreign Application Priority Data
Dec. 10, 2020 (KR) 10-2020-0172471

(51) Int. Cl. H02S 40/22; H02S 10/40; B63B 35/44

(52) U.S. Cl. CPC H02S 40/22; B63B 2035/4453; B63B 35/44; H02S 10/40

(57) ABSTRACT

The present invention relates to a solar photovoltaic system suitably used for agriculture or used on water and including a reflector for reflecting sunlight.

According to the present invention, a solar photovoltaic system includes a solar cell panel and a reflector spaced a predetermined distance from the solar cell panel. Here, at least a portion of a reflection surface of the reflector, which faces the solar cell panel, has a convexly curved surface.

### CROSS-REFERENCE TO RELATED APPLICATIONS

This U.S. non-provisional patent application claims priority under 35 U.S.C. § 119 of Korean Patent Application No. 10-2020-0172471, filed on Dec. 10, 2020, the entire contents of which are hereby incorporated by reference.

### BACKGROUND

The present invention relates to a solar photovoltaic system suitably used for agriculture or used on water and including a reflector for reflecting sunlight.

Interest and necessity on renewable energy has grown as safely usable and sustainable energy due to global warming and the nuclear accident in Japan. A solar photovoltaic technology is distributed as an inevitable measure and politically supported even in this country highly dependent on fossil fuels.

However, since a current solar photovoltaic system is generally installed on land such as forest and farmland, the solar photovoltaic system may damage nature and give an adverse effect on animals and plants.

The solar photovoltaic technology for agriculture, which is applied to improve the above-described situation, is a method for cultivating farmland and simultaneously performing solar power generation such that about 30% of a sunshine amount is used for solar power generation, and the rest is used for producing corps to maintain 80% or more of a harvest amount. Thus, the solar photovoltaic technology for agriculture may improve added value of farms and vitalize farming villages.

However, a narrow solar cell panel including 32 cells and installed on a support that is typically spaced apart form the ground is applied to the solar photovoltaic system for agriculture in order to preserve the sunshine amount, thereby maintaining a yield of corps at a predetermined level,

In general, a structure to which the solar cell panel is attached includes a support, a truss support, and an independent support and installed to have a spaced height of 3 m or more upward from the ground and maintain a light shielding rate of about 30%. Also, since an area of the installed panel is restricted based on an area of farmland, a power generation amount per unit area is limited.

The solar photovoltaic system on water may be advantageous to use idle water surface such as a lake or sea and have a natural cooling effect through the water surface, thereby improving the solar power generation amount. However, the solar photovoltaic system on water is necessary to further improve a power generation efficiency.

### RELATED ART DOCUMENT

### [Patent Document]

(Patent document 1) Korean Patent Publication No. 2020-0134065

### SUMMARY

The present invention provides a solar photovoltaic system capable of maintaining or increasing a power generation efficiency while reducing a light shielding rate of a solar cell installed on farmland in which corps are grown.

The present invention also provides a solar photovoltaic system installed on sea or water and capable of increasing a power generation efficiency.

In an embodiment of the present invention to achieve the objects, a solar photovoltaic system includes: a solar cell panel; and a reflector spaced a predetermined distance from the solar cell panel. Here, at least a portion of a reflection surface of the reflector, which faces the solar cell panel, has a convexly curved surface.

In the solar photovoltaic system, incident light is reflected at a relatively high angle by an upper portion of a reflection surface of the reflector because the upper portion of the reflection surface of the reflector has a curved surface convex toward a surface thereof, and incident light is reflected at a relatively low angle by a lower portion of the reflection surface. Thus, the reflector may irradiate an entire surface of the solar cell panel, which faces the reflection surface, to increase a power generation efficiency of the solar cell panel.

Also, a bottom surface of the reflector may be attached adjacent to or spaced a predetermined distance from the solar cell panel. A distance between the bottom surface of the reflector and the solar cell panel may be adjusted in consideration of a place and a light shielding rate, and the reflector may be installed adjacent to the solar cell panel in consideration of the light shielding rate.

Also, the solar photovoltaic system may further include a support, and the solar cell panel and the reflector may be disposed on the support. The support may minimize shadow caused by the solar photovoltaic system and have a predetermined height (typically, 3 m or more) from the ground. Also, the support may have various shapes such as a truss shape or an independent pole shape as long as the shape of the support does not give a great effect (e.g., the light shielding rate) on crop growing.

Also, the solar photovoltaic system may be installed on farmland in which crops are grown. Since the solar photovoltaic system according to the present invention has a structure maintaining a power generation amount while minimizing the light shielding rate to the farmland, the solar photovoltaic system may be suitably used for agriculture.

Also, the solar cell panel may have an inclination angle to the ground in a range from 60° to 120°. The installation angle of the solar cell panel to the ground is a factor of directly affecting the light shielding rate caused by the solar photovoltaic system. Thus, the solar cell panel may be installed in a maximally standing shape. When the installation angle to the ground is deviated from the range from 60° to 120°, an effect of reducing the light shielding rate on crops, which is the object of the present invention, may not be obtained. Thus, the range may be inevitably maintained. A further preferable angle may be in a range from 80° to 100°.

Also, the reflector may have a height equal to or less than that of the solar cell panel. As the height of the reflector increases, the light shielding rate may increase, but light reflected at a high angle by the upper portion of the reflector may not be reflected to the solar cell panel when the height of the reflector increases. Thus, the height of the reflector may have a height of ½ or less of a height of the solar cell panel.

In another embodiment of the present invention to achieve the objects, the solar photovoltaic system may further include: a floating structure disposed below the solar cell panel and the reflector to allow the solar cell panel and the reflector to float on water; and a breakwater structure disposed on the floating structure to prevent waves from colliding with the solar cell panel. Here, the reflector may be formed on the breakwater structure. In this system, as the reflector is formed on the breakwater structure for protecting the solar cell panel, the solar cell panel may be protected, and a power generation efficiency of the solar cell may improve by reflected light.

Also, the floating structure may include the breakwater structure.

That is, the floating structure and the breakwater structure may be integrated with each other. Through this, safety of the floating structure and the breakwater structure may increase.

Also, the reflector may be integrated with the breakwater structure. That is, the reflector may be formed on an inclined surface of the breakwater structure.

Also, the reflector may be inclined so that an internal angle between a bottom surface of the reflector and a bottom surface of the solar cell panel is in a range from 60° to 150°. When the installation angle is deviated from the range from 60° to 150°, the light shielding rate to the ground may increase, or the power generation efficiency may be reduced.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a side view illustrating a solar photovoltaic system for agriculture according to a first embodiment of the present invention;

FIG. 2 is a perspective view illustrating the solar photovoltaic system for agriculture according to the first embodiment of the present invention;

FIG. 3 is a view for explaining a reflection angle of a curved reflector used in the first embodiment of the present invention;

FIG. 4 is a view for comparing light shielding areas of the first embodiment of the present invention and a typical solar power system for agriculture; and

FIG. 5 is a side view illustrating a floating type solar photovoltaic system according to a second embodiment of the present invention.

### DETAILED DESCRIPTION

Hereinafter, the configuration and effects of embodiments of the present invention will be described with reference to the accompanying drawings.

Hereinafter, detailed descriptions related to well-known functions or configurations will be ruled out in order not to unnecessarily obscure subject matters of the present invention. Furthermore, when it is described that one comprises (or includes or has) some elements, it should be understood that it may comprise (or include or has) only those elements, or it may comprise (or include or have) other elements as well as those elements if there is no specific limitation.

### First Embodiment

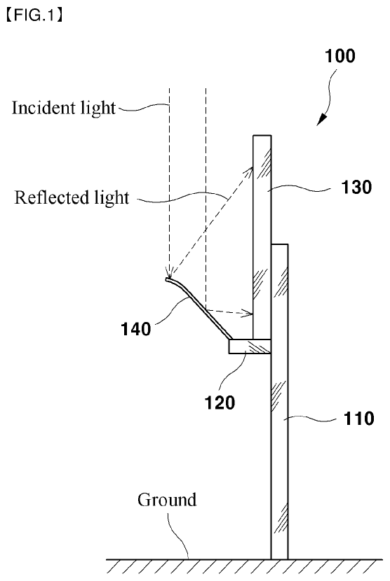

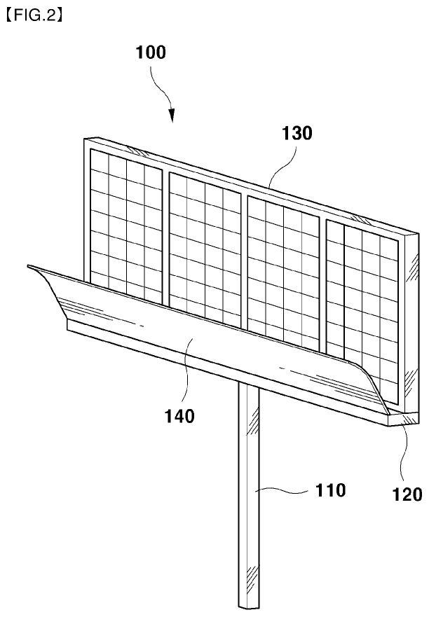

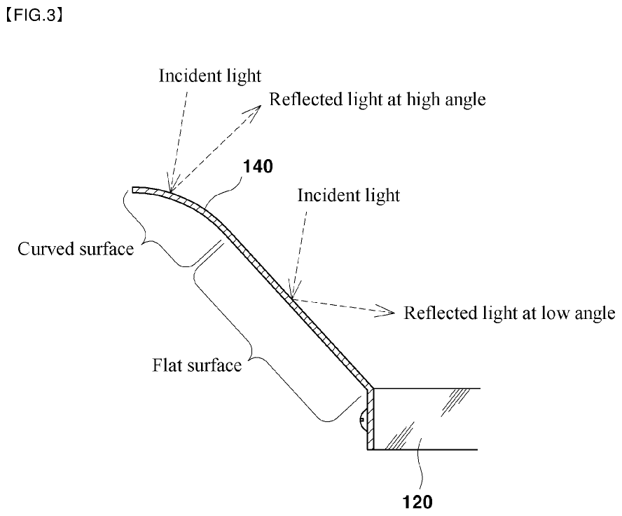

FIG. 1 is a side view illustrating a solar photovoltaic system for agriculture according to a first embodiment of the present invention, FIG. 2 is a perspective view illustrating the solar photovoltaic system for agriculture according to the first embodiment of the present invention, and FIG. 3 is a view for explaining a reflection angle of a curved reflector used in the first embodiment of the present invention.

Referring to FIGS. 1 to 2, a solar photovoltaic system 100 for agriculture according to the first embodiment of the present invention includes a support 110 fixed to the ground, a holder 120 fixed to one side of an upper portion of the support 110, a solar cell panel 130 held on the support 120 and fixed to the support 110, and a reflector 140 that is inclinedly disposed and spaced a predetermined distance from the solar cell panel 130.

The support 110 is built approximately perpendicular to farmland in which crops are grown and has a bar shape made of a material such as metal and concrete. The support 110 has one end firmly fixed to a fixture such as concrete installed on the farmland. The support 110 may be made of a circular or polygonal pipe member so that the holder 120 coupled to the support 110 is easily coupled with the solar cell panel 130.

Although the independent pole-type support is suggested in the first embodiment of the present invention, various types of supports such as a truss type support may be used.

The holder 120 is a plate-type member installed perpendicularly to the support 110 at a position spaced a predetermined distance from an upper end of the support 110. Various well-known coupling units such as a bolt and a nut may be used as a coupling unit for fixing the holder 120 to the support 110.

The solar cell panel 130 is a module for performing power generation by sunlight incident thereto and configured such that one or a plurality of solar cells are fixed in an approximately rectangular frame for fixing the solar cell. The solar cell panel 130 includes an output terminal for transmitting generated electricity to the outside.

The solar cell panel 130 has a lower frame fixed to the support 120 through the coupling unit such as a bolt and an upper frame fixed to the support 110 through the coupling unit such as a bolt. Here, the solar cell panel 130 is installed approximately perpendicular to the ground at a high angle. Although the solar cell panel 130 is installed perpendicular to the ground in the first embodiment of the present invention, the solar cell panel 130 may be installed to be slightly inclined within a range from 60° to 120° as described above. When the solar cell panel 130 having a large solar light shielding area is installed at a high angle to the ground, a light shielding rate to crops grown below the solar cell panel 130 may be remarkably reduced.

The reflector 140 is configured such that a reflective layer for reflecting the sunlight is formed on one surface of a substrate having a plate shape having a convexly curved upper portion and a flat lower portion on the drawing. The lower portion of the reflector 140 is coupled to the holder 120 by using the coupling unit such as a bolt and inclined at a predetermined angle to the solar cell panel 130.

Here, the reflector 140 may be installed so that an internal angle between the flat lower portion of the reflector 140 and a lower portion of the solar cell panel 130 is in a range from 60° to 150°. The range of the internal angle is in the range from 60° to 150° because a power generation efficiency decreases when the angle is less than 60° and a light shielding rate increases as the light shielding area of the reflector 140 increases when the angle is greater than 150°.

Although the reflector having the curved upper portion is described in this embodiment, an effect of reducing the light shielding rate may be obtained when the curved shape is applied to top and bottom surfaces or left and right surfaces, or the reflector has an overall curved shape (including a semi-spherical shape). Thus, the embodiment includes a case when the curved shape is applied to the entire reflector.

Also, the reflector 140 may have a height equal to or less than that of the solar cell panel 130. When the height of the reflector 140 is greater than that of the solar cell panel 130, an amount in which sunlight reflected at a high angle from the upper portion of the reflector 140 is not incident to the solar cell panel 130 increases, and the light shielding area increases.

FIG. 3 is a view for explaining a reflection angle of the curved reflector used in the first embodiment of the present invention.

Since the curved reflector of the first embodiment has the convexly curved upper portion as shown in FIG. 3, the curved upper portion reflects incident light at a relatively high angle to the solar cell panel, and the flat lower portion reflects the incident light at a relatively low angle to the solar cell panel. In the present invention, the feature of ‘being reflected at a relatively high angle’ represents that the reflection angle to the ground is great, and the feature of ‘being reflected at a relatively low angle’ represents that the reflection angle to the ground is small.

Thus, reflected light that is reflected at a high angle from the curved upper portion of the reflector heads toward the upper portion of the solar cell panel 130, and reflected light that is reflected from the flat lower portion of the reflector heads toward the lower portion of the solar cell panel 130 although the reflector is disposed adjacent to the solar cell panel 130. Through this, although the reflector has a size smaller than that of the panel, sunlight may be reflected to an entire surface of the panel having a high inclination angle, shadow generated by the panel and the reflector may be minimized, and a low light shielding rate may be maintained.

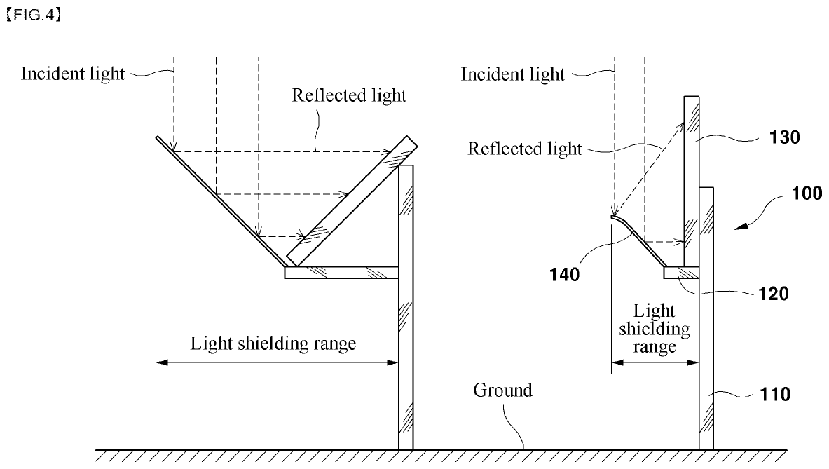

FIG. 4 is a view for comparing light shielding areas of the first embodiment of the present invention and a typical solar photovoltaic system for agriculture.

As illustrated in FIG. 4, when a typical case in which a solar cell panel installed at a low inclination angle to the ground and a flat reflector installed adjacent to the solar cell panel are applied is compared with the case when the reflector having the curved portion is applied to the solar cell panel installed at the high inclination angle, it may be known that a shadow area of the case according to the first embodiment of the present invention is remarkably reduced further than that typical case, assuming that vertical light is incident for each case. That is, the solar photovoltaic system for agriculture according to the first embodiment of the present invention may remarkably reduce the light shielding rate or obtain better power generation efficiency at the same light shielding rate than the typical solar photovoltaic system for agriculture.

### Second Embodiment

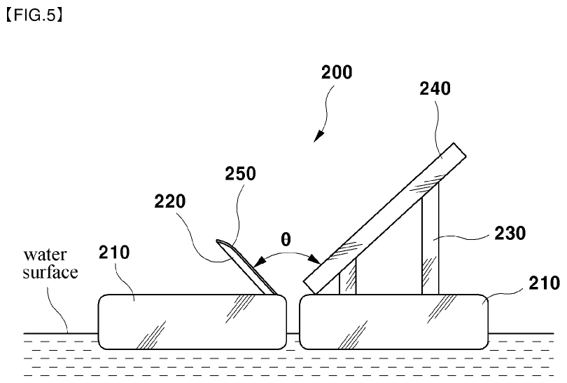

FIG. 5 is a side view illustrating a floating type solar photovoltaic system according to a second embodiment of the present invention.

Referring to FIG. 5, a floating type solar photovoltaic system according to the second embodiment of the present invention includes a floating structure 210 disposed on water surface to provide buoyancy, a breakwater structure 220 fixed to one side of an upper portion of the floating structure 210, a holder 230 fixed to the other side of the upper portion of the floating structure 210, a solar cell panel 240 fixed to the holder 230, and a reflector 250 formed on the breakwater structure 220.

The floating structure 210 has an approximately cuboid shape and is manufactured by a filament winding method. In general, the floating structure 210 may maintain a floating function for a predetermined period even when the floating structure is damaged by an external impact by filling styrofoam particles therein.

The breakwater structure 220 is a structural member made of an approximately plate type member and having excellent corrosion resistance and great strength per unit weight. The breakwater structure 220 is preferably made of pultruded fiber reinforced polymeric plastic (PFRP). The breakwater structure 220 is inclined at a predetermined angle to the solar cell panel 240 for preventing so-called wave overtopping by which a wave generated from water surface overflows to the solar cell panel to damage the solar cell panel. Also, a surface of the breakwater structure 220, which faces the solar cell panel 240, has an upper portion having a convexly curved surface and a lower portion having a flat surface.

Although the breakwater structure having the curved upper portion is described in this embodiment, an effect of reducing the light shielding rate may be obtained when the curved shape is applied to top and bottom surfaces or left and right surfaces, or the breakwater structure has an overall curved shape (including a semi-spherical shape). Thus, the embodiment includes a case when the curved shape is applied to the entire breakwater structure.

The holder 230 is a support structure for fixing the solar cell panel 240 onto the floating structure 210 and made of a pipe material having a bar shape.

The solar cell panel 240 is a module for performing power generation by sunlight incident thereto and configured such that one or a plurality of solar cells are fixed in an approximately rectangular frame for fixing the solar cell. The solar cell panel 240 includes an output terminal for transmitting generated electricity to the outside.

The solar cell panel 240 is inclined at a predetermined angle to the water surface by the holder 230.

The reflector 250 is attached to the surface of the breakwater structure 220, which faces the solar cell panel 240. The reflector 250 may include a substrate including non-metal and metal materials such as a polymer film and a stainless steel thin plate, a resin film formed on the substrate, a reflection layer formed on the resin film, and a protection layer formed on the reflection layer. The reflector 250 may be coupled onto the breakwater structure 220 by an attaching, bonding, or coupling method.

When the reflector 250 having the curved shape is installed to reflect sunlight to the solar cell panel 240, the reflector 250 may produce reflected light at a high angle and a low angle to the entire surface of the solar cell panel 240 although a size of the reflector 250 is reduced to improve a power generation amount. That is, as a result of applying the reflector including the curved shape and the flat shape to the solar cell panel installed at a vertical inclination angle, it is checked that a daily power generation amount increases in a range from 5.7% to 13.5% as a solar radiation amount is varied in comparison with a case when the solar cell panel is installed at an angle of 30° without the reflector.

The solar photovoltaic system according to an embodiment of the present invention may maintain the power generation amount and simultaneously reduce the light shielding rate to the farmland by installing the solar cell panel at the high angle to the ground and installing the reflector to be adjacent to the solar cell panel. Thus, the production amount of the crops per unit area and/or the power generation amount may increase.

Also, the solar photovoltaic system according to another embodiment of the present invention may protect the solar cell panel and simultaneously improve the power generation amount by forming the reflector on the breakwater structure for protecting the solar cell panel.

Although the embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. A solar photovoltaic system comprising:
a solar cell panel; and
a reflector spaced a predetermined distance from the solar cell panel,
wherein at least a portion of a reflection surface of the reflector, which faces the solar cell panel, has a convexly curved surface.

2. The solar photovoltaic system of claim 1, wherein a bottom surface of the reflector is attached adjacent to the solar cell panel.

3. The solar photovoltaic system of claim 1, further comprising a support,
wherein the solar cell panel and the reflector are disposed on the support.

4. The solar photovoltaic system of claim 3, wherein the solar photovoltaic system is installed on farmland in which crops are grown.

5. The solar photovoltaic system of claim 4, wherein the solar cell panel has an inclination angle to the ground in a range from 60° to 120°.

6. The solar photovoltaic system of claim 4, wherein the solar cell panel has an inclination angle to the ground in a range from 80° to 100°.

7. The solar photovoltaic system of claim 4, wherein the reflector has a height equal to or less than that of the solar cell panel.

8. The solar photovoltaic system of claim 1, further comprising:
a floating structure disposed below the solar cell panel and the reflector to allow the solar cell panel and the reflector to float on water.

9. The solar photovoltaic system of claim 8, further comprising:
a breakwater structure disposed on the floating structure to prevent waves from colliding with the solar cell panel,
wherein the reflector is formed on the breakwater structure.

10. The solar photovoltaic system of claim 8, wherein the floating structure comprises the breakwater structure.

11. The solar photovoltaic system of claim 9, wherein the reflector is attached to the breakwater structure in an integrated manner.

12. The solar photovoltaic system of claim 1, wherein the reflector is inclined so that an internal angle between a bottom surface of the reflector and a bottom surface of the solar cell panel is in a range from 60° to 150°.

13. The solar photovoltaic system of claim 2, wherein the reflector is inclined so that an internal angle between a bottom surface of the reflector and a bottom surface of the solar cell panel is in a range from 60° to 150°.

14. The solar photovoltaic system of claim 3, wherein the reflector is inclined so that an internal angle between a bottom surface of the reflector and a bottom surface of the solar cell panel is in a range from 60° to 150°.

15. The solar photovoltaic system of claim 8, wherein the reflector is inclined so that an internal angle between a bottom surface of the reflector and a bottom surface of the solar cell panel is in a range from 60° to 150°.
